(19) United States
(12) Patent Application Publication
(10) Pub. No.: US 2026/0029579 A1
(43) Pub. Date: Jan. 29, 2026

(54) OPTICAL CONNECTOR

(71) Applicant: Nippon Telegraph and Telephone Corporation, Tokyo (JP)

(72) Inventors: Ryo Koyama, Musashino-shi, Tokyo (JP); Yoshiteru Abe, Musashino-shi, Tokyo (JP); Kazunori Katayama, Musashino-shi, Tokyo (JP)

(21) Appl. No.: 18/994,296

(22) PCT Filed: Jul. 29, 2022
(86) PCT No.: PCT/JP2022/029304

§ 371 Date: Jan. 14, 2025

(51) Int. Cl. G02B 6/245; G02B 6/38

(52) U.S. Cl. CPC G02B 6/245; G02B 6/3803

(57) ABSTRACT

An optical connector includes an aligning mechanism including an inlet, into which an optical fiber wire that includes a coating covering a bare optical fiber is inserted, and an outlet of the aligning mechanism. The aligning mechanism includes a plurality of protrusions disposed at intervals in a circumferential direction around a central axis of the aligning mechanism and protruding toward the central axis. Each protrusion is formed of a material that is harder than the coating of the optical fiber wire and softer than the bare optical fiber. The protrusion includes a distal end portion facing the central axis. A diameter of the smallest virtual circle, among virtual circles in contact with the distal end portion in a plane perpendicular to the central axis, is equal to or more than a diameter of the bare optical fiber and smaller than an outer diameter of the optical fiber wire.

### TECHNICAL FIELD

The present invention relates to an optical connector to which an optical fiber wire is attached.

### BACKGROUND ART

When constructing an optical communication network using optical fibers, work of attaching optical connectors to the optical fibers is frequently performed at a work site. Patent Literature 1 discloses an optical connector capable of reducing this work load. The optical connector disclosed in Patent Literature 1 includes a ferrule in which an optical fiber is built in. In the ferrule is formed a through-hole, to which the optical fiber having a length shorter than that of the ferrule is fixed, extending along the central axis of the ferrule. The optical fiber in the through-hole is exposed to one end surface of the ferrule facing a mating connector.

An inner diameter of the through-hole formed in the ferrule is slightly larger than an outer diameter of a bare optical fiber configuring the optical fiber wire and is sufficiently smaller than an outer diameter of the optical fiber wire. The through-hole therefore functions as a coating removal portion for the optical fiber wire. That is, the optical fiber wire attached to the optical connector abuts on the other end surface of the ferrule in which the through-hole is opened. Further, when inserting the optical fiber wire into the through-hole, a coating around the bare optical fiber is peeled off, and only the bare optical fiber enters the through-hole to optically connect to the built-in optical fiber.

### CITATION LIST

### Patent Literature

Patent Literature 1: JP 2009-12850 A

### SUMMARY OF INVENTION

### Technical Problem

Meanwhile, bare optical fibers are often eccentric in coatings of the optical fiber wires. An external force and a side pressure applied during storage and laying and bending, in addition to a manufacturing error in manufacturing, causes larger deformation to the coatings because of a difference in rigidity between the coating mainly made of a resin and the bare optical fiber mainly made of silica-based glass, so that the bare optical fiber becomes eccentric. Therefore, for example, when attaching the optical fiber wire to the optical connector including the built-in optical fiber and the ferrule described above, the position of the bare optical fiber may shift with respect to the through-hole of the ferrule serving as the coating removal portion. In this case, the bare optical fiber cannot be attached.

The present invention has been made in view of the above circumstances, and an object of the present invention is to provide an optical connector capable of reducing the burden of mounting work even with an optical fiber wire whose bare optical fiber is eccentric.

### Solution to Problem

An optical connector according to an aspect of the present invention includes an aligning mechanism including an inlet, into which an optical fiber wire that includes a coating covering a bare optical fiber is inserted, and an outlet of the aligning mechanism, in which the aligning mechanism includes a plurality of protrusions disposed at intervals in a circumferential direction around a central axis of the aligning mechanism and protruding toward the central axis. Each protrusion is formed of a material that is harder than the coating of the optical fiber wire and softer than the bare optical fiber, each protrusion includes a distal end portion facing the central axis, and a diameter of the smallest virtual circle, among virtual circles in contact with the distal end portion in a plane perpendicular to the central axis, is equal to or more than a diameter of the bare optical fiber and smaller than an outer diameter of the optical fiber wire.

### Advantageous Effects of Invention

The present invention is capable of providing an optical connector capable of reducing the burden of mounting work even with an optical fiber wire whose bare optical fiber is eccentric.

### BRIEF DESCRIPTION OF DRAWINGS

FIG. 1 is a sectional view of an example of an optical fiber wire to be attached to an optical connector according to an embodiment.

FIG. 2 is a sectional view of an example of an optical connector to which an aligning mechanism according to the embodiment is applied.

FIG. 3 is a perspective view illustrating a positional relationship between the aligning mechanism and a coating removal portion in the optical connector illustrated in FIG. 2.

FIG. 4 is a perspective view of the aligning mechanism according to the embodiment.

FIG. 5 is a front view of the aligning mechanism according to the embodiment viewed from an outlet side, FIG. 5(a) is a view illustrating the entire aligning mechanism, FIG. 5(b) is an enlarged front view of an example of a distal end portion of a protrusion according to the embodiment, and FIG. 5(c) is an enlarged front view of another example of the distal end portion of the protrusion according to the embodiment.

FIG. 6 is a sectional view including a central axis of the aligning mechanism according to the embodiment.

FIG. 7A is a sectional view illustrating the optical fiber wire inserted into the aligning mechanism according to the embodiment.

FIG. 7B is a sectional view illustrating the optical fiber wire inserted into the aligning mechanism according to the embodiment.

FIG. 7C is a sectional view illustrating the optical fiber wire inserted into the aligning mechanism according to the embodiment.

FIG. 7D is a sectional view illustrating the optical fiber wire inserted into the aligning mechanism according to the embodiment.

FIG. 7E is a sectional view illustrating the optical fiber wire inserted into the aligning mechanism according to the embodiment.

FIG. 7F is a sectional view illustrating the optical fiber wire to be inserted into the coating removal portion through the aligning mechanism according to the embodiment.

FIG. 8 is a view illustrating a modification of a disposition of the protrusion according to the embodiment.

FIG. 9 is a perspective view of a modification of the aligning mechanism according to the embodiment.

### DESCRIPTION OF EMBODIMENTS

Hereinafter, an optical connector according to some embodiments of the present invention will be described. Note that parts common in the drawings are denoted by the same reference numerals, and redundant description will be omitted.

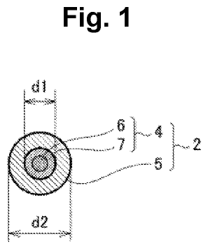

FIG. 1 is a sectional view of an example of an optical fiber wire (a coated optical fiber) 2 to be attached to an optical connector according to the present embodiment. As illustrated in FIG. 1, the optical fiber wire 2 includes a bare optical fiber 4 and a coating 5 surrounding the bare optical fiber 4. Further, the bare optical fiber 4 includes a core 6 containing quartz glass as a main component and a cladding 7. The bare optical fiber 4 has an outer diameter d1 of, for example, 125 μm. The optical fiber wire 2 has an outer diameter d2 of, for example, 0.25 mm. The material of the coating 5 is, for example, an ultraviolet curable resin such as a urethane acrylate-based resin, a polyamide resin, or the like. Further, the coating 5 is a protective layer of the optical fiber wire 2 and may include at least one colored layer.

Next, configurations of an optical connector 10 will be described.

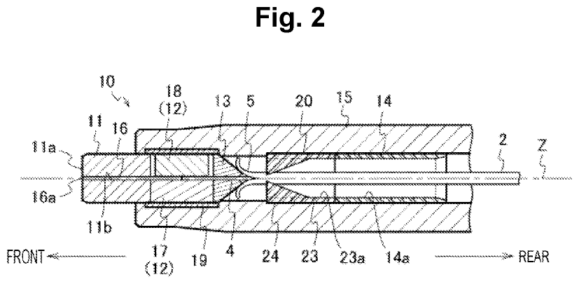

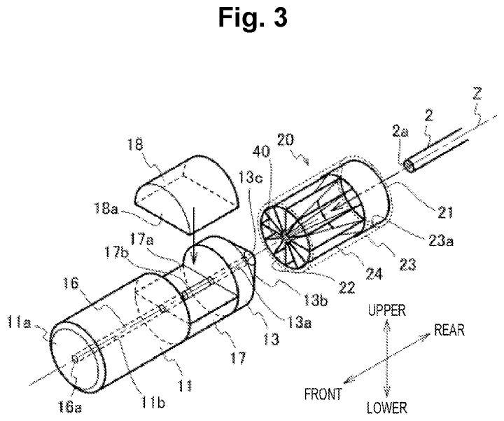

FIG. 2 is a sectional view of an example of the optical connector 10 to which an aligning mechanism 20 according to the present embodiment is applied. FIG. 3 is a perspective view illustrating a positional relationship between the aligning mechanism 20 and a coating removal portion 13 in the optical connector 10 illustrated in FIG. 2. As illustrated in FIG. 2, the bare optical fiber 4 of the optical fiber wire 2 is optically connected, inside the optical connector 10, to a short optical fiber 16 incorporated in a ferrule 11.

A central axis Z will be defined in the following description. The central axis Z is a central axis of each of the ferrule 11, the coating removal portion 13, the aligning mechanism 20, and a guide portion 14. In the ferrule 11, the short optical fiber 16 and the bare optical fiber 4 of the optical fiber wire 2 are placed on the central axis Z, for example. Further, a circumferential direction and a radial direction each centered on the central axis Z are respectively referred to as a circumferential direction CD and a radial direction RD.

The optical fiber wire 2 is inserted into the optical connector 10 from the rear toward the front. The optical connector 10 is connected to an optical connection member (not illustrated) such as an optical connector placed in front of the optical connector. The optical fiber wire 2 is thus optically connected to an optical element or an optical fiber provided in the optical connection member (not illustrated).

As illustrated in FIG. 2, the optical connector 10 includes the ferrule 11, a fiber fixing portion 12, the coating removal portion 13, the aligning mechanism 20, and the guide portion 14. These members are arranged from the front to the rear along the central axis Z of the optical connector 10, and are accommodated in, for example, a connector main body 15 which serves as an accommodating unit. Note that the optical connector 10 also includes a gripping portion (not illustrated) that grips the optical fiber wire 2. The gripping portion (not illustrated) is attached to the rear end of the connector main body 15 and stably grips the optical fiber wire 2 optically connected to the short optical fiber 16.

The ferrule 11 is attached to a front end portion of the connector main body 15. As illustrated in FIG. 3, the ferrule 11 is a columnar member, and is formed of ceramics such as zirconia having high weather resistance and high mechanical strength. A through-hole 11b is formed on the central axis Z of the ferrule 11. The short optical fiber 16 is fixed in the through-hole 11b. A front end 16a of the short optical fiber 16 is exposed to a front end surface 11a of the ferrule 11.

The fiber fixing portion 12 is provided behind the ferrule 11. As illustrated in FIG. 3, the fiber fixing portion 12 sandwiches the short optical fiber 16 and the bare optical fiber 4 of the optical fiber wire 2 against each other by mechanical splice. Note that a refractive index matching agent (not illustrated) is filled (or applied) between these optical fibers.

The fiber fixing portion 12 includes a base portion 17 and a lid portion 18. Each of the base portion 17 and the lid portion 18, for example, has a substantially semicircular cross section centered on the central axis Z and extends along the central axis Z. The base portion 17 has a plane 17a parallel to the central axis Z. A groove portion 17b is formed in the plane 17a. The groove portion 17b has, for example, a V-shaped cross section and extends along the central axis Z.

The lid portion 18 is provided above the base portion 17. The lid portion 18 has a plane 18a facing the plane 17a of the base portion 17. The base portion 17 and the lid portion 18 are sandwiched by a clamp 19 with their planes 17a and 18a facing each other. As a result, the short optical fiber 16 and the bare optical fiber 4 placed in the groove portion 17b are sandwiched between the base portion 17 and the lid portion 18.

The coating removal portion 13 is provided behind the fiber fixing portion 12. As illustrated in FIG. 3, the coating removal portion 13 is a columnar member centered on the central axis Z. An insertion hole 13a for the bare optical fiber 4 is formed on the central axis Z of the coating removal portion 13. The insertion hole 13a has a diameter slightly larger than the diameter of the bare optical fiber 4. Further, the coating removal portion 13 may have a tapered surface 13b at the rear portion of the coating removal portion 13. The tapered surface 13b approaches the central axis Z toward the rear.

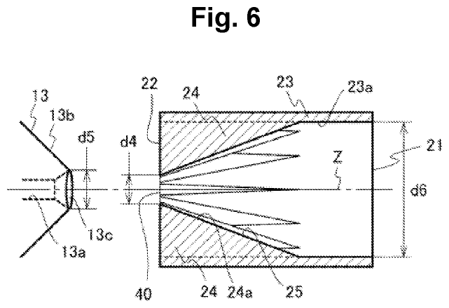

The diameter of the insertion hole 13a at the rear end side may increase toward the rear so as to easily guide a distal end of the bare optical fiber 4 toward the front. That is, the rear end of the insertion hole 13a may be formed in a flared shape. In this case, a diameter d5 of a circular region 13c, formed by the rear edge of the insertion hole 13a, is larger than the diameter of a virtual circle 40 (see FIG. 6). The virtual circle 40 is, among circles in contact with the distal end portions 24a of all protrusions 24 in a plane perpendicular to the central axis Z, the smallest circle obtained when freely moving the plane (for example, along the central axis Z). Note that the center of each of the region 13c and the virtual circle 40 is located substantially on the central axis Z. When viewed from the front or the rear, the virtual circle 40 is thus located in the region 13c.

The aligning mechanism 20 is provided behind the coating removal portion 13. This aligning mechanism 20 will be described later in detail.

The guide portion 14 is provided behind the aligning mechanism 20. The guide portion 14 is provided with, for example, a guide hole 14a which is a tubular member centered on the central axis Z and extends along the central axis Z. The guide hole 14a has the same cross-sectional shape as that of an inlet 21 of the aligning mechanism 20. Further, the rear end of the guide hole 14a is formed in a flare shape toward the rear and guides a distal end of the optical fiber wire 2 toward the front.

Next, the aligning mechanism 20 will be described.

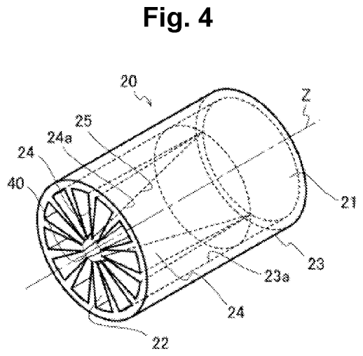

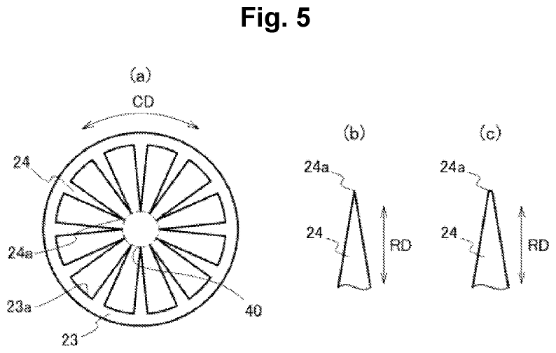

FIG. 4 is a perspective view of the aligning mechanism 20 according to the present embodiment. FIG. 5(a), FIG. 5(b), and FIG. 5(c) are each a front view of the aligning mechanism 20 viewed from an outlet side, FIG. 5(a) is a view illustrating the entire aligning mechanism 20, FIG. 5(b) is an enlarged front view of an example of a distal end portion 24a of the protrusion 24 according to the present embodiment, and FIG. 5(c) is an enlarged front view of another example of the distal end portion 24a of the protrusion 24 according to the present embodiment. FIG. 6 is a sectional view of the aligning mechanism 20 including the central axis Z.

As illustrated in FIG. 4 and FIG. 5(a), the aligning mechanism 20 includes a hollow cylindrical portion 23 centered on the central axis Z and a plurality of the protrusions 24. The rear end of the cylindrical portion 23 is the inlet 21 of the optical fiber wire 2, and the front end of the cylindrical portion 23 is an outlet 22 of the optical fiber wire 2. The cylindrical portion 23 includes an inner peripheral surface 23a centered on the central axis Z. A diameter d6 of the inner peripheral surface 23a (see FIG. 6) is constant along the central axis Z.

Each protrusion 24 is a plate-like member that protrudes toward the central axis Z and extends in a direction parallel to the central axis Z. The protrusion 24 is disposed, with a gap of a predetermined length, in the circumferential direction CD around the central axis Z. Note that the protrusion 24 may be formed in a spindle shape such as a cone or a pyramid whose vertex protrudes toward the central axis Z. In this case, the protrusion 24 may have a flat (in other words, stretched) shape in the direction parallel to the central axis Z.

Each protrusion 24 includes a distal end portion 24a facing the central axis Z. The diameter d4 of the smallest virtual circle 40, among the virtual circles perpendicular to the central axis Z and in contact with these distal end portions 24a, is equal to or more than a diameter d1 of the bare optical fiber 4 of the optical fiber wire 2 and smaller than the outer diameter d2 of the optical fiber wire 2. That is, the protrusion 24 protrudes toward the central axis Z so as to satisfy this condition. Further, in a cross section perpendicular to the central axis Z, the interval between the two distal end portions 24a adjacent to each other may be shorter than the diameter of the bare optical fiber 4. In this case, the bare optical fiber 4 can be prevented from entering between the two adjacent protrusions 24.

The protrusion 24 is made of a material harder than the coating 5 of the optical fiber wire 2 and softer than the bare optical fiber 4. Such a material is, for example, a synthetic resin having higher hardness than that of the coating 5 and lower hardness than that of glass which is the material of the bare optical fiber 4.

As illustrated in FIG. 5(a), a width of the distal end portion 24a of the protrusion 24 along the circumferential direction CD may be constant, or may increase radially outward from the distal end portion 24a. In the latter case, it is more likely to apply local pressure to the coating 5 of the optical fiber wire 2 than in the former case. That is, deformation of the coating 5, which will be described later, is more likely to be promoted in the latter case.

As illustrated in FIG. 5(b), the distal end portion 24a of the protrusion 24 may have a cross-sectional shape capable of cutting the coating 5 of the optical fiber wire 2. That is, the distal end portion 24a may have a sharp distal end shape such as a blade or a wedge. In this case, it is possible to reduce a force required for inserting the optical fiber wire 2 that deforms the coating 5. Here, in addition to the shape described above, the distal end portion 24a may have any shape that enables the coating 5 to be deformed. For example, the distal end portion 24a may be rounded as illustrated in FIG. 5(c), or may have other shapes.

Each of the plurality of protrusions 24 has a shape that deforms (in other words, that can deform) the coating 5 of the optical fiber wire 2 toward the central axis Z by insertion of the optical fiber wire 2. Such a shape is illustrated in FIG. 6. As illustrated in FIG. 6, the protrusion 24 extends in a direction from the inlet 21 toward the outlet 22 of the aligning mechanism 20. This extending direction may be parallel to the central axis z, or may be inclined with respect to the central axis Z. In addition, the distal end portion 24a of the protrusion 24 each includes a tapered portion 25 that approaches the central axis Z toward the outlet 22 from the inlet 21 of the aligning mechanism 20.

Meanwhile, the bare optical fiber 4 is typically eccentric in the optical fiber wire 2 according to the present embodiment. When attaching the optical fiber wire 2 to the optical connector 10, on the other hand, the bare optical fiber 4 needs to finally abut against the short optical fiber 16 in the ferrule 11. That is, it is necessary to guide the bare optical fiber 4 to a position where the bare optical fiber 4 can be inserted into the through-hole 11b of the ferrule 11. The optical connector 10 includes the aligning mechanism 20 in order to perform this guidance.

Next, action of the aligning mechanism 20 when attaching the optical fiber wire 2 will be described.

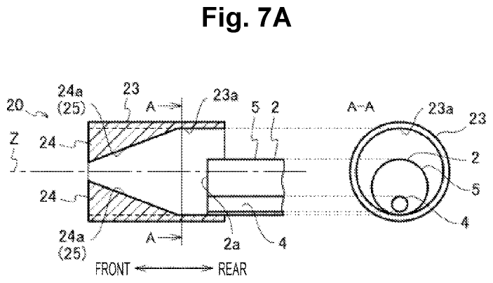

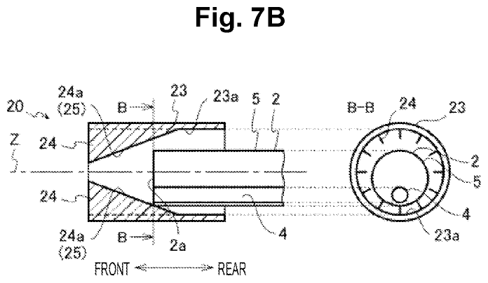

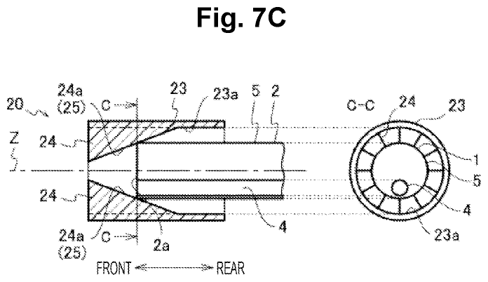

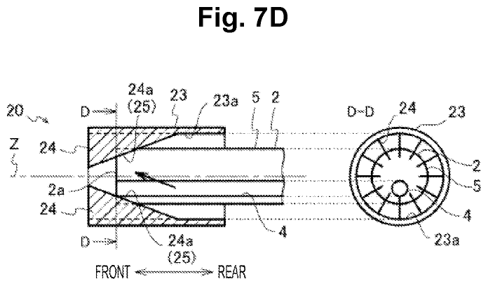

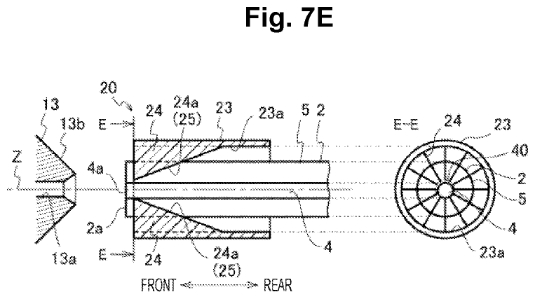

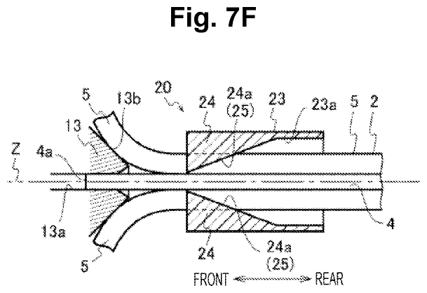

FIG. 7A to FIG. 7E are sectional views illustrating changes in the position and the shape of the optical fiber wire 2 in stages, when the optical fiber wire 2 passes through the aligning mechanism 20. The left side in each drawing illustrates a cross section including the central axis Z. Further, the right side in each drawing illustrates a cross section perpendicular to the central axis Z. The position of each of these cross sections is indicated by a line with an alphabet in the sectional view on the left side. Further, FIG. 7F is a sectional view illustrating the optical fiber wire 2 inserted into the coating removal portion 13 through the aligning mechanism 20.

When attaching the optical fiber wire 2 to the optical connector 10, the optical fiber wire 2 is inserted, through the guide portion 14 and the aligning mechanism 20, from the rear of the connector main body 15 toward the through-hole 11b of the ferrule 11. However, the coating 5 is removed in the process of inserting the optical fiber wire 2, and only the bare optical fiber 4 reaches the through-hole 11b of the ferrule 11, as described later.

FIG. 7A illustrates a state in which a distal end 2a of the optical fiber wire 2 has reached the inlet 21 of the aligning mechanism 20. As illustrated in FIG. 7A, the distal end 2a of the optical fiber wire 2 is often in contact with the inner peripheral surface 23a of the cylindrical portion 23 due to deflection of the optical fiber wire 2, gravity, or the like.

When the optical fiber wire 2 is further inserted from the state illustrated in FIG. 7A, the optical fiber wire 2 moves forward, and the distal end 2a of the optical fiber wire 2 comes into contact with the protrusion 24 (see FIG. 7B). In the example of FIG. 7B, the distal end 2a of the optical fiber wire 2 is in contact with one of a plurality of the tapered portions 25. The optical fiber wire 2 is therefore allowed to move in a direction perpendicular to the central axis Z in this state. The distal end 2a of the optical fiber wire 2 thus moves toward the central axis Z (upward in FIG. 7B) caused by contact with the tapered portion 25, while moving forward. In this manner, the tapered portion 25 smoothly guides the optical fiber wire 2 toward the central axis Z.

When the optical fiber wire 2 is further inserted from the state illustrated in FIG. 7B, the distal end 2a of the optical fiber wire 2 comes into contact with the distal end portions 24a of all the protrusions 24 (see FIG. 7C). The center of the coating 5 is thus located on the central axis Z in this state. The center of the bare optical fiber 4, however, remains eccentric.

The movement of the cylindrical portion 23 in the direction perpendicular to the central axis Z is restricted because the cylindrical portion 23 is accommodated in the connector main body 15. Further, the protrusion 24 is harder than the coating 5. When the optical fiber wire 2 is further pushed forward from the state illustrated in FIG. 7C, the coating 5 is thus pressed from the protrusion 24 toward the central axis Z. On the other hand, spaces are formed between the adjacent protrusions 24 along the circumferential direction CD. A portion of the coating 5 that is not in contact with the protrusion 24 is thus allowed to deform radially outward. When the optical fiber wire 2 is pushed forward with the distal end 2a of the optical fiber wire 2 being in contact with all the protrusions 24, the coating 5 thus starts to deform. Specifically, a portion of the coating 5 that is in contact with the protrusion 24 deforms radially inward, while the portion of the coating 5 that is not in contact with the protrusion 24 deforms radially outward. At this time, if the distal end portion 24a of the protrusion 24 is formed to be sharp, the distal end portion 24a cuts into the coating 5 (see FIG. 7D).

As the deformation of the coating 5 progresses due to further insertion of the optical fiber wire 2, the distal end portions 24a of the protrusion 24 approaches the bare optical fiber 4 (see FIG. 7D). The movement perpendicular to the central axis Z of the bare optical fiber 4 remains permitted; therefore, the bare optical fiber 4 receives the pressing of the protrusion 24 and moves toward the central axis Z (see FIG. 7D). Note that the protrusion 24 is softer than the bare optical fiber 4. Therefore, even if the protrusion 24 comes into contact with the bare optical fiber 4 due to cutting into the coating 5 or the like, the bare optical fiber 4 is not damaged.

As described above, the diameter d4 of the virtual circle 40 which is in contact with the distal end portion 24a of the protrusion 24 is equal to or more than the diameter d1 of the bare optical fiber 4 and smaller than the outer diameter d2 of the optical fiber wire 2. The virtual circle 40 is located at or near the outlet 22 of the aligning mechanism 20. When the optical fiber wire 2 is further inserted from the state illustrated in FIG. 7D, the bare optical fiber 4 thus enters the region in the virtual circle 40 and is exposed from the outlet 22 of the aligning mechanism 20 (see FIG. 7E). The coating 5 is, on the other hand, also exposed from the outlet 22 of the aligning mechanism 20 in a deformed state.

The insertion hole 13a formed in the coating removal portion 13 is located on the central axis Z. That is, the distal end 4a of the bare optical fiber 4 that has passed through the aligning mechanism 20 faces the insertion hole 13a. When the optical fiber wire 2 is further inserted, the bare optical fiber 4 thus enters the insertion hole 13a and faces the short optical fiber 16 in the fiber fixing portion 12. The bare optical fiber 4 and the short optical fiber 16 are clamped by the fiber fixing portion 12. The coating 5, on the other hand, is peeled off (removed) from the bare optical fiber 4 and moves along the tapered surface 13b of the coating removal portion 13 (see FIG. 7F).

According to the present embodiment, even the optical fiber wire in which the bare optical fiber is eccentric can be easily attached to the optical connector without removing the coating before being attached to the optical connector, as described above. That is, work load of attaching the optical fiber wire can be reduced.

Next, some modifications of the present embodiment will be described.

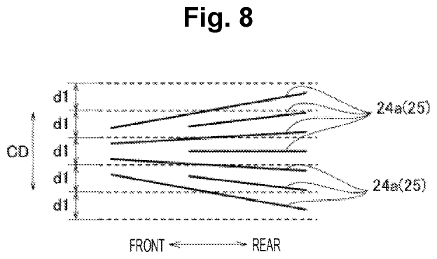

FIG. 8 is a view illustrating a modification of a disposition of the protrusions 24. FIG. 8 is a view in which the position of the distal end portion 24a of the protrusion 24 is developed in the circumferential direction CD. As illustrated in FIG. 8, the number of protrusions 24 along the circumferential direction CD may decrease from the inlet 21 toward the outlet 22 of the aligning mechanism 20.

When the tapered portion 25 is formed in the protrusion 24, the interval between the two distal end portions 24a adjacent to each other in the circumferential direction CD narrows toward the outlet 22 of the aligning mechanism 20. On the other hand, it is sufficient that the interval between the two distal end portions 24a, which are separated from and in contact with each other, is set to a value about the diameter of the bare optical fiber 4. The aligning mechanism 20 is, for example, formed by molding using a mold. Formation of the protrusions 24 can thus be facilitated by reducing the number of the protrusions 24, which enables a reduction in cost for manufacturing the mold.

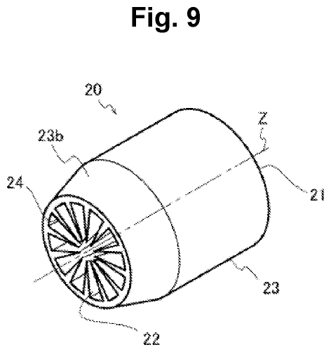

FIG. 9 is a perspective view of a modification of the aligning mechanism 20. As illustrated in FIG. 9, the cylindrical portion 23 of the aligning mechanism 20 may include a tapered outer peripheral surface 23b that approaches the central axis Z toward the outlet 22 of the aligning mechanism 20. In this case, the optical connector 10 includes a member including an inner peripheral surface (not illustrated), which forms a cross section complementary to a cross section formed by the outer peripheral surface 23b. Such a member is, for example, the connector main body 15. The member on which the inner peripheral surface described above is formed, however, may be a component (not illustrated) of the optical connector 10 provided separately from the connector main body 15, as long as the position of the aligning mechanism 20 with respect to the insertion hole 13a of the coating removal portion 13 can be appropriately positioned.

The aligning mechanism 20 is accommodated in, for example, the connector main body 15 including the inner peripheral surface corresponding to the outer peripheral surface 23b; therefore, positional displacement of the aligning mechanism 20 along the radial direction with respect to the central axis Z can be inhibited.

### REFERENCE SIGNS LIST

2 Optical fiber wire (coated optical fiber)
4 Bare optical fiber
Coating
6 Core
7 Cladding
10 Optical connector
11 Ferrule
12 Fiber fixing portion
13 Coating removal portion
14 Guide portion
15 Connector main body
16 Short optical fiber
17 Base portion
18 Lid portion
19 Clamp
20 Aligning mechanism
21 Inlet
22 Outlet
23 Cylindrical portion
24 Protrusion
24a Distal end portion
25 Tapered portion
40 Virtual circle

1. An optical connector comprising:
an aligning mechanism including an inlet, into which an optical fiber wire that includes a coating covering a bare optical fiber is inserted, and an outlet of the aligning mechanism, wherein:
the aligning mechanism includes:
a plurality of protrusions disposed at intervals in a circumferential direction around a central axis of the aligning mechanism and protruding toward the central axis,
the protrusions are each formed of a material that is harder than the coating of the optical fiber wire and softer than the bare optical fiber,
the protrusions each include a distal end portion facing the central axis, and
a diameter of a smallest virtual circle, among a plurality of virtual circles in contact with the distal end portion in a plane perpendicular to the central axis, is equal to or larger than a diameter of the bare optical fiber and smaller than an outer diameter of the optical fiber wire.

2. The optical connector according to claim 1, wherein;
the protrusions each extend in a direction from the inlet toward the outlet of the aligning mechanism, and
each distal end portion of each of the protrusions includes a tapered portion that approaches the central axis toward the outlet from the inlet of the aligning mechanism.

3. The optical connector according to claim 1, wherein
a width of the distal end portion of each of the protrusions along the circumferential direction increases radially outward from the distal end portion.

4. The optical connector according to claim 3, wherein
the distal end portion of each of the protrusions has a cross-sectional shape capable of cutting the coating of the optical fiber wire.

5. The optical connector according to claim 2, wherein
a number of the protrusions along the circumferential direction decreases from the inlet to the outlet of the aligning mechanism.

6. The optical connector according to claim, wherein:
the aligning mechanism includes a cylindrical portion that is positioned radially outward of the protrusions and supports the protrusions, and
the cylindrical portion includes a tapered outer peripheral surface that approaches the central axis toward the outlet of the aligning mechanism.
